(19) United States
(12) Patent Application Publication
(10) Pub. No.: US 2011/0136366 A1
(43) Pub. Date: Jun. 9, 2011

(54) Locking mechanism for a computer signal line connector

(75) Inventor: Mao-Lin Hwang, Chung Ho City (TW)

(73) Assignee: Uniconn Corp.

(21) Appl. No.: 11/892,999

(22) Filed: Aug. 29, 2007

(30) Foreign Application Priority Data
Sep. 25, 2006 (TW) 095217086

(51) Int. Cl. H01R 13/62

(52) U.S. Cl. 439/345

(57) ABSTRACT

A locking mechanism for a computer signal line connector includes at least a housing, a circuit board and a cable, and can be inserted with a signal connection line between a computer motherboard and a hard disk. Above the housing is provided with a locking mechanism which is composed of a lock piece, an operation stick, a V-shape pad, and an upper housing having a trench corresponding to the V-shape pad. Upon assembling for use, the operation stick is pushed forward or pulled backward, allowing a front end of the lock piece above the operation stick to be lifted up for unlocking, in order to achieve an effect of assembling and applying conveniently.

### BACKGROUND OF THE INVENTION

a) Field of the Invention

The present invention relates to a locking mechanism for a computer signal line connector, and more particularly to a locking mechanism of a high speed transmission connector for connecting a motherboard with a hard disk, wherein the locking mechanism of the high speed transmission connector (or the round cable connector) is composed of a lock piece, an operation stick, a V-shape pad, and an upper housing having a trench which corresponds to the V-shape pad, such that by pushing forward or pulling backward the operation stick, the mechanism can be unlocked, thereby providing with an effect of assembling and applying conveniently.

b) Description of the Prior Art

It is known that a signal line between a computer motherboard and a hard disk is a flat-shape cable which is assembled parallel from plural sets of wires. As flexibility of that flat-shape cable is limited by direction, it is relatively inconvenient in using and is easier to take up space. Therefore, there is recently a kind of signal connection line made by a circular cable wire, also called a round cable, to improve the shortcoming of the aforementioned conventional flat-shape cable.

However, an ordinary conventional high speed transmission connector (as shown in FIG. 4) includes primarily an upper housing 41, a circuit board 42, a cable 43 and a lower housing 44, whereas a surface of the upper housing 41 of that connector is provided with a locking mechanism 45 which contains a lock piece 451 and a push handle 452. The lock piece 451 is in a T-shape, with two sides of a transversal plate at its rear end being provided respectively with a small hole 4511 for transfixing with a screw 46, so as to be fixed on an upper surface of the upper housing 41. An end part extending forward from a straight plate of the lock piece 451 is provided with a tilt surface 4512 which is tilted downward by an angle, and two sides at an end part of that tilt surface 4512 are bended downward with a hook 4513, respectively. The push handle 452 is clamped between the lock piece 451 and the surface of the upper housing 41, and can move forward and backward reciprocally. A front end of the push handle 452 is disposed with a flat plate 4521 which extends forward, and a rear end is disposed with a push part 4522 which can be gripped. According to the aforementioned conventional structure, when it is inserted and assembled with a corresponding connector (omitted in the drawing), the hooks 4513 of the locking mechanism will be automatically hooked onto a metallic housing corresponding to a front end of the connector, thereby achieving an effect of locking to prevent from dropping off. Upon unlocking (as shown in FIG. 5), the push handle 452 is pushed forward by the push part 4522, which enables a front end of the flat plate 4521 which extends forward to be abutted at a bottom surface of the tilt surface 4512 at the front end of the lock piece 451, to lift up the hooks 4513 which are in an suspension state at the front end of the lock piece 451, thereby achieving an effect of unlocking.

Accordingly, in applying the aforementioned conventional structure, the front end of the lock piece 451 can be only warped upward by pushing forward the push handle 452 to be abutted at the tilt surface 4512 at the front end of the lock piece 451, in order to achieve the effect of unlocking. Therefore, the unlocking effect can be only resulted in one direction, which causes inconvenience in application. In addition, for the conventional structure, it is unlocked by lifting up the lock piece 451 with the front end of the flat plate 4521; therefore, when the flat plate 4521 of the push handle 452 pushes forward, bending deformation will occur easily due to insufficient compression strength of material itself, resulting in that it is not easy to lift up the lock piece 451 and thereby causing inconvenience in operation and application to a user.

Furthermore, referring to FIG. 6, it shows a schematic view of another conventional structure, wherein a housing 61 is provided with a lock piece 62, and a pull handle 63 which is clamped between the lock piece 62 and an upper surface of the housing 61, and is able to move forward and backward reciprocally. A front end of the upper surface of the housing 61 is provided with a tilt surface 611, and two sides at an end part of the lock piece 62 that is tilted and extending forward are bended downward respectively with a hook 621. The pull handle 63 is provided with a downward flange 631 between the housing 61 and a tilt surface at a front end of the lock piece 62, and a rear end of the pull handle 63 is provided with a grip part 632. Upon assembling the conventional structure for application, only an action of pulling back can be performed, which uses an upward displacement of the flange 631 at the front end of the pull handle 63 along the tilt surface 611 at the front end of the housing 61, to lift up the hooks 621 at the front end of the lock piece 62 for constituting an unlocking state. As the flange 631 does not have any support if it is pushing forward, it is not able to effectively lift up the lock piece 62, thereby causing imperfection in usage. Accordingly, for the aforementioned two conventional structures, improvement is actually needed.

### SUMMARY OF THE INVENTION

The primary object of the present invention is to provide a locking mechanism for a computer signal line connector, which is provided with a simple mechanism and is able to easily achieve an effect of unlocking by pushing or pulling an operation stick.

Accordingly, the locking mechanism for a computer signal line connector of the present invention includes primarily an upper housing, a circuit board, a cable and a lower housing, can be inserted with a signal connection line between a computer motherboard and a hard disk, and uses a locking mechanism above the upper housing to hook with a corresponding connector, for preventing the signal line from dropping off to result in a signal break-off. The locking mechanism is composed of a lock piece, an operation stick, a V-shape pad, and an upper housing having a V-shape trench corresponding to the V-shape pad. The lock piece is in a T-shape, and two sides of a transversal plate at a rear end of the lock piece are provided respectively with a small hole for transfixing with a screw, in order to be fixed on a surface of the upper housing. An end part extending forward from a straight plate of the lock piece is provided with a tilt surface which is tilted downward by an angle, and two sides at an end part of that tilt surface are bended downward with a hook, respectively. The operation stick is clamped between the lock piece and the surface of the upper housing, and can move forward and backward reciprocally. A front end of a flat plate which extends forward from the operation stick is provided with a V-shape support part, and a rear end is provided with a grip part. Upon assembling, the V-shape pad is latched onto the V-shape trench on the surface of the upper housing, and then the operation stick is emplaced on the V-shape pad, allowing the V-shape support part at its front end to move on the V-shape pad, followed by covering with the lock piece and fixing by locking.

Upon using the aforementioned structure, the operation stick can be pushed forward or pulled backward to lift up the lock piece by the V-shape support part, according to a relative movement and contact between the V-shape support part at the front end of the operation stick, and the V-shape pad, which allows the front end of the lock piece to be lifted upward for unlocking, thereby achieving an effect of assembling and applying conveniently.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of an embodiment of the present invention.

FIG. 2 shows a schematic view of the present invention after being assembled.

FIG. 3 shows a cutaway view of the present invention after being assembled.

FIG. 4 shows an exploded view of a conventional structure.

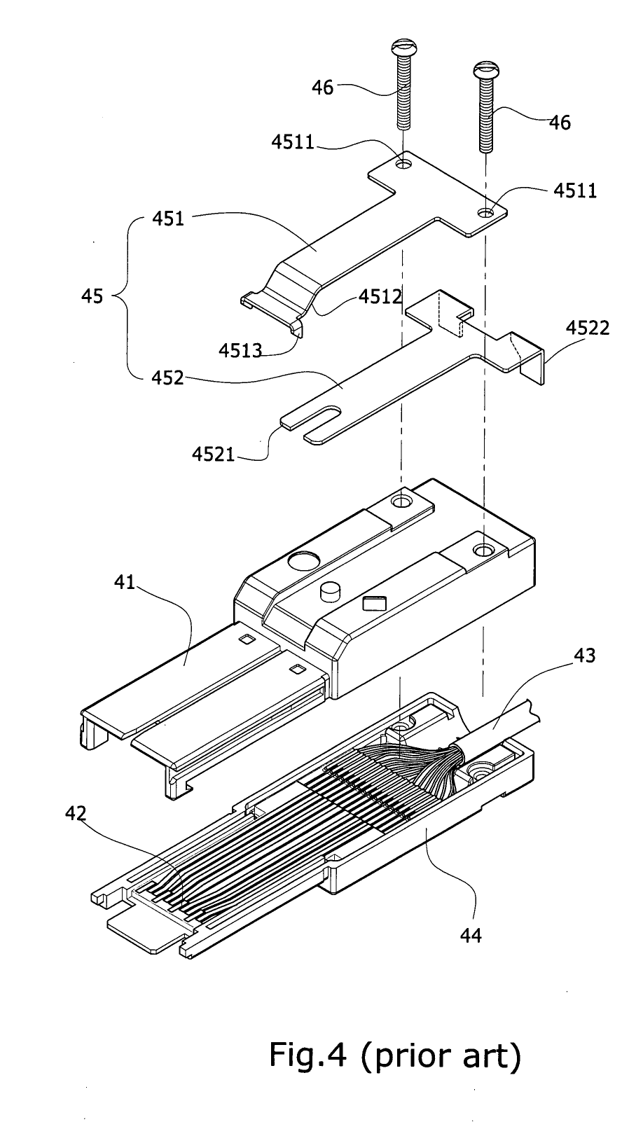

FIG. 5 shows a cutaway view of an assembly in FIG. 4.

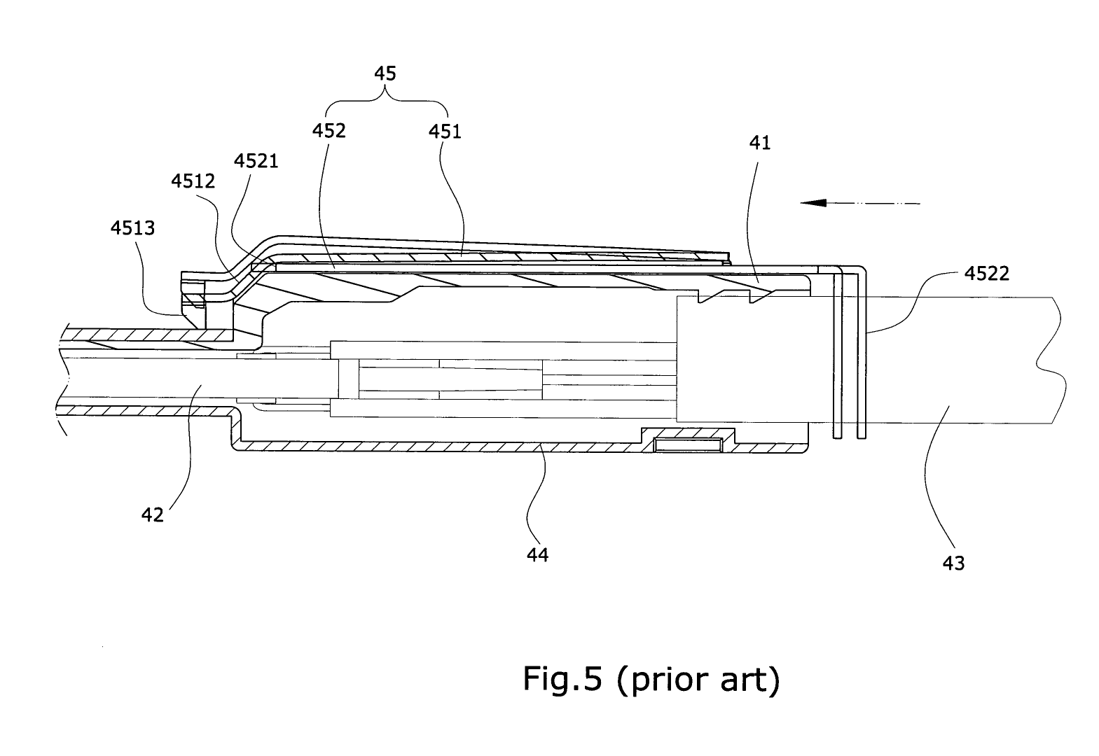

FIG. 6 shows a schematic view of another conventional structure.

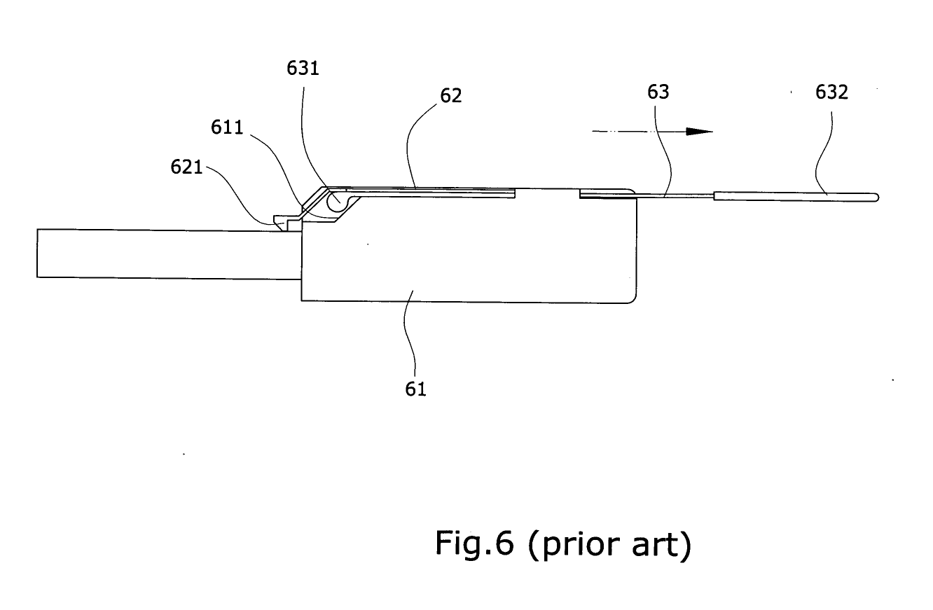

### DETAILED DESCRIPTION OF THE PREFERRED EMBODIMENTS

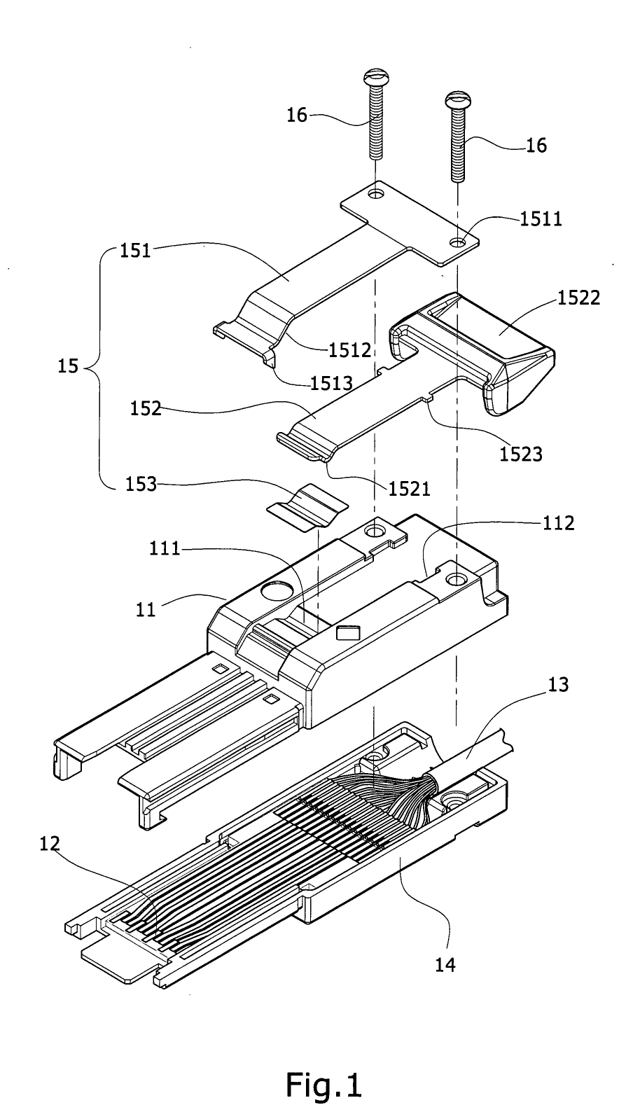

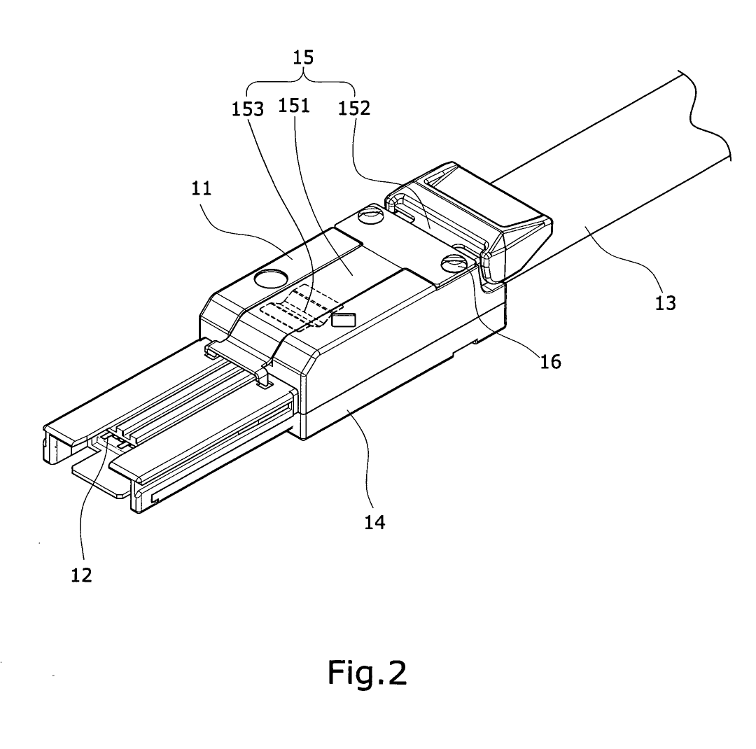

Referring to FIG. 1 and FIG. 2, a locking mechanism for a computer signal line connector of the present invention comprises primarily an upper housing 11, a circuit board 12, a cable 13 and a lower housing 14, can be inserted with a signal connection line between a computer motherboard and a hard disk, and uses a locking mechanism 15 above the upper housing 11 to lock with a corresponding connector, so as to prevent the signal line from dropping off to result in a signal break-off. The locking mechanism 15 is composed of a lock piece 151, an operation stick 152, a V-shape pad 153, and an upper housing 11 having a V-shape trench 111 corresponding to the V-shape pad. The lock piece 151 is in a T-shape, with two sides of a transversal plate at a rear end being provided respectively with a small hole 1511 for transfixing with a screw 16, in order to be fixed on an upper surface of the upper housing 11. An end part extending forward from a straight plate of the lock piece 151 is provided with a tilt surface 1512 which is tilted downward by an angle, and two sides at an end part of that tilt surface 1512 are bended downward with a hook 1513, respectively. The operation stick 152 is clamped between the lock piece 151 and the upper surface of the upper housing 11, and can move forward and backward reciprocally. A front end of a flat plate extending forward from the operation stick 152 is provided with a V-shape support part 1521, and a rear end is provided with a grip part 1522. Upon assembling, the V-shape pad 153 is latched onto the V-shape trench 111 on the surface of the upper housing 11, and then the operation stick 152 is emplaced on the V-shape pad 153, allowing the V-shape support part 1521 at the front end to move on the V-shape pad 153, followed by covering with the lock piece 151 and fixing by locking with the screws 16.

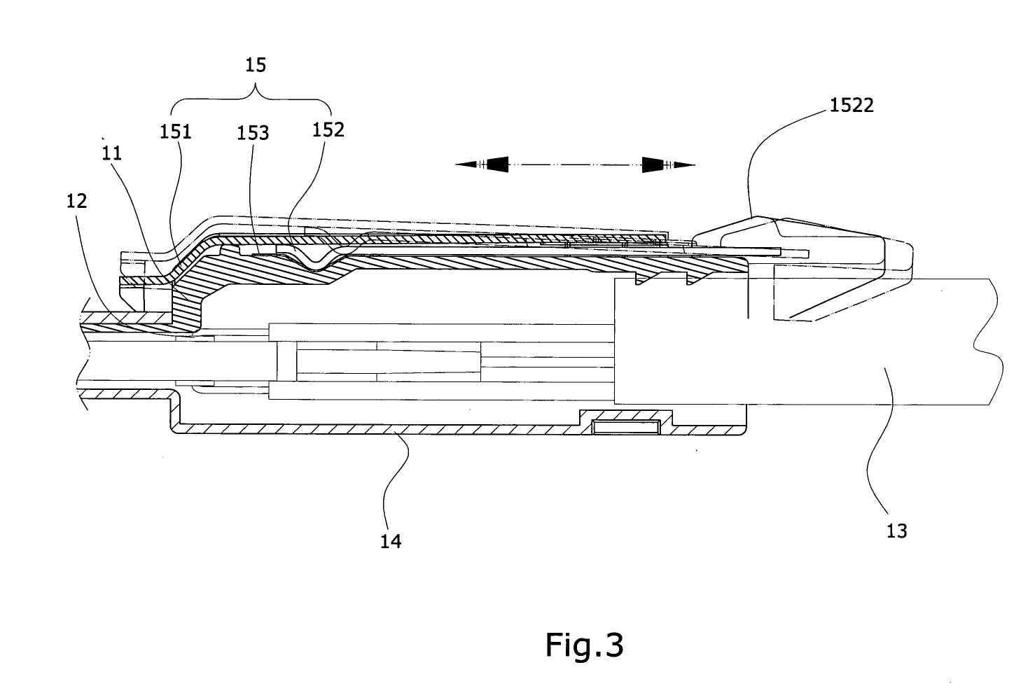

While using the aforementioned structure, the grip part 1522 at the rear end of the operation stick 152 can be held to exert an action of pushing forward or pulling backward (as shown in FIG. 3, which only shows the action of pulling backward), allowing the V-shape support part 1521 to lift up the lock piece 151 along the tilt surface at the rear side, due to that the V-shape support part 1521 has escaped from a concaved location of the V-shape pad 153, by using a relative movement and contact between the V-shape support part 1521 at the front end of the operation stick 152, and the V-shape pad 153, thereby enabling the hooks 1513 at the front end of the lock piece 151 to be lifted upward for forming an unlocking state. On the contrary, the V-shape support part 1521 can also lift up the lock piece 151 along the tilt surface in front of the V-shape pad 153 by pushing forward the operation stick 152, to achieve the same unlocking function, wherein when the operation stick 152 is pulled backward particularly, there will be no bending deformation to the operation stick 152, and the lock piece 151 can be lifted up more conveniently and effectively, thereby achieving an object of assembling and applying conveniently. Moreover, as the grip part 1522 is made by plastic injection, it provides a better sense of touch upon holding and its appearance and color can be altered according to a user's requirement.

Referring to FIG. 1, upon implementing the embodiment, proper positions at two sides of a groove on the upper housing 11 for emplacing the operation stick 152 are provided with limiting slots 112, and two sides of the operation stick 152 are provided with protrusion parts 1523 which extend toward interiors of the limiting slots 112, such that when the operation stick 152 is pushed forward or pulled backward, a positioning effect is available to prevent the operation stick 152 from being displaced excessively to drop off.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A locking mechanism for a computer signal line connector, comprising at least a housing, a circuit board and a cable, being inserted with a signal connection line between a computer motherboard and a hard disk, and using a locking mechanism above the housing to lock with a corresponding connector, so as to prevent the signal line from easily dropping off; the locking mechanism being composed of a lock piece, an operation stick, a V-shape pad, and an upper housing having a trench corresponding to the V-shape pad; the lock piece being in a T-shape, two sides of a transversal plate at a rear end being provided respectively with a small hole for transfixing with a screw, in order to be fixed on an upper surface of the housing, an end part extending forward from a straight plate of the lock piece being provided with a tilt surface which is tilted downward by an angle, and two sides at an end part of the tilt surface being bended downward with a hook, respectively; the operation stick being clamped between the lock piece and the upper surface of the housing, and moving forward and backward reciprocally; a front end of a flat plate extending forward from the operation stick being provided with a V-shape support, and a rear end being provided with a grip part; upon assembling, the V-shape pad being latched onto the V-shape trench on the upper surface of the housing, then the operation stick being emplaced on the V-shape pad, allowing the V-shape support part at the front end to move on the V-shape pad, followed by covering with the lock piece and fixing by locking.

2. The locking mechanism for a computer signal line connector according to claim 1, wherein the grip part of the operation stick is made by plastic injection.

3. The locking mechanism for a computer signal line connector according to claim 1, wherein proper positions at two sides of a groove on the upper housing for emplacing the operation stick are provided with limiting slots, and two sides of the operation stick are provided with protrusion parts which extend toward interiors of the limiting slots, thereby allowing the operation stick to be provided with a positioning effect upon pushing forward or pulling backward.
